(19) United States
(12) Patent Application Publication
(10) Pub. No.: US 2008/0190310 A1
(43) Pub. Date: Aug. 14, 2008

(54) METHOD FOR COATING A PRINTING PRESS CYLINDER

(75) Inventors: Ralph KLARMANN, Augsburg (DE); Christian Fuchs, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsbury (DE)

(21) Appl. No.: 12/028,570

(22) Filed: Feb. 8, 2008

(30) Foreign Application Priority Data
Feb. 10, 2007 (DE) 10 2007 006 705.6

(51) Int. Cl. C25D 3/04; C25D 3/12; B41F 13/10

(52) U.S. Cl. 101/375; 205/271; 205/283

(57) ABSTRACT

A method for coating a printing press cylinder, namely a plate cylinder or a transfer cylinder, is disclosed. In an embodiment, the method includes providing a printing press cylinder with a metallic cylinder basic body, which has an outer surface area and at least one lockup slot, and applying a coating containing nickel to the cylinder basic body in the region of the outer surface area as well as in the region of the, or each, lockup slot by autocatalytic and/or chemical deposition.

This application claims the priority of German Patent Document No. 10 2007 006 705.6, filed Feb. 10, 2007, the disclosure of which is expressly incorporated by reference herein.

### BACKGROUND AND SUMMARY OF THE INVENTION

The invention relates to method for coating a printing press cylinder. In addition, the invention relates to a printing press cylinder.

A method for coating a printing press cylinder is known from German Patent Document No. DE 103 49 446 B4, whereby a cylinder basic body of the printing press cylinder has an outer surface area and at least one lockup slot. According to DE 103 49 446 B4, the inner surface of the, or each, lockup slot is coated with nickel and phosphorous by chemical deposition. On the other hand, the surface area of the cylinder basic body is coated using thermal spraying.

In the case of the coating method according to DE 103 49 446 B4, a coating with a thickness of between 0.2 mm and 0.5 mm forms in the region of the outer surface area of the cylinder basic body. Such thick coatings cannot be applied uniformly and true-to-contour so that after coating, the printing press cylinder has to be refinished. This is disadvantageous.

Starting herefrom, the present invention is based on the objective of creating a novel method for coating a printing press cylinder as well as creating a novel printing press cylinder.

In an embodiment, the inventive method includes at least the following steps: a) providing a printing press cylinder with a metallic cylinder basic body, which has an outer surface area and at least one lockup slot; and b) applying a coating containing nickel to the cylinder basic body in the region of the outer surface area as well as in the region of the, or each, lockup slot by autocatalytic and/or chemical deposition.

The inventive method permits the formation of a relatively thin, true-to-contour and uniform coating of a printing press cylinder so that no refinishing of the printing press cylinder is required after coating.

Then a coating containing chromium is preferably applied to the coating containing nickel at least in the region of the outer surface area of the cylinder basic body by electrodeposition.

Preferred developments of the invention are yielded from the following description.

### DETAILED DESCRIPTION OF THE EXEMPLARY EMBODIMENT

The present invention relates to a method for coating a printing press cylinder, namely a plate cylinder or a transfer cylinder, whereby to do so, in a first step of the inventive method, a metallic cylinder basic body is provided, which has an outer surface area and at least one lockup slot. After providing the metallic cylinder basic body, a coating containing nickel is applied to the cylinder basic body in the region of its outer surface area as well as in the region of the, or each, lockup slot by autocatalytic deposition.

In the case of the autocatalytic and/or chemical deposition, an alloy, which contains at least nickel and phosphorous, is applied to the cylinder basic body in the region of its outer surface area as well as in the region of the, or each, lockup slot. The autocatalytic and/or chemical deposition takes place in such a manner that the applied coating containing nickel has a thickness of at least 15 μm. The thickness of the coating containing nickel applied by autocatalytic and/or chemical deposition is preferably at least 25 μm, in particular at least 30 μm. The maximum thickness of this coating containing nickel applied by the autocatalytic and/or chemical deposition is 50 μm.

After the cylinder basic body has been completely coated with the coating containing nickel in the region of the outer surface area as well as in the region of the, or each, lockup slot, a coating containing chromium is preferably applied by electrodeposition to the coating containing nickel at least in the region of the outer surface area of the cylinder basic body, preferably exclusively in the region of the outer surface area of the cylinder basic body. The electrodeposition takes place in such a manner that the coating containing chromium applied by electrodeposition has a thickness of at least 15 μm, in particular a thickness of at least 30 μm. The maximum thickness of this coating containing chromium applied by electrodeposition is 100 μm.

The coating containing chromium applied by electrodeposition can be embodied as a single layer. However, the coating containing chromium applied by electrodeposition is preferably embodied as multiple layers, whereby each of the applied layers has a thickness of at least 10 μm, preferably a thickness of at least 15 μm.

When the coating containing chromium applied by electrodeposition is embodied as multiple layers, a layer of hot chromium is preferably applied directly to the coating containing nickel and at least one layer of hard chromium is applied to the layer of hot chromium. In contrast to this, it is also possible to apply several layers of hard chromium directly to the coating containing nickel.

Accordingly, it is within the scope of the present invention to coat a metallic cylinder basic body of a printing press cylinder initially with a coating containing nickel completely in the region of its outer surface area as well as in the region of the, or each, lockup slot by autocatalytic and/or chemical deposition. The thickness of this coating containing nickel is preferably at least 15 μm. A coating containing chromium having a thickness of preferably at least 30 μm is applied to this coating containing nickel by electrodeposition.

The invention makes it possible to coat printing press cylinders true-to-contour and uniformly with relatively low layer thicknesses so that no refinishing of the printing press cylinder is required after coating.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for coating a printing press cylinder, namely a plate cylinder or a transfer cylinder, comprising:
a) providing a printing press cylinder with a metallic cylinder basic body, which has an outer surface area and a lockup slot; and
b) applying a coating containing nickel to the cylinder basic body in a region of the outer surface area and in a region of the lockup slot by autocatalytic and/or chemical deposition.

2. The method according to claim 1, wherein an alloy containing nickel and phosphorous is applied to the cylinder basic body by the autocatalytic and/or chemical deposition.

3. The method according to claim 1, wherein the autocatalytic and/or chemical deposition takes place in such a manner that the applied coating containing nickel has a thickness of at least 15 μm.

4. The method according to claim 3, wherein the applied coating containing nickel has a thickness of at least 25 μm.

5. The method according to claim 1, wherein following step b), a coating containing chromium is applied to the coating containing nickel at least in the region of the outer surface area of the cylinder basic body.

6. The method according to claim 5, wherein the coating containing chromium is applied by electrodeposition in at least one layer on the cylinder basic body.

7. The method according to claim 5, wherein the coating containing chromium is applied exclusively in the region of the outer surface area of the cylinder basic body.

8. The method according to claim 6, wherein the electrodeposition takes place in such a manner that the coating containing chromium applied by electrodeposition has a thickness of at least 15 μm.

9. The method according to claim 8, wherein the coating containing chromium applied by electrodeposition has a thickness of at least 30 μm.

10. The method according to claim 6, wherein several layers of chromium are applied on the cylinder basic body by electrodeposition in such a manner that each layer has a thickness of at least 10 μm.

11. The method according to claim 1, wherein a layer of hot chromium and at least one layer of hard chromium are applied by electrodeposition.

12. The method according to claim 1, wherein several layers of hard chromium are applied by electrodeposition.

13. A printing press cylinder, namely a plate cylinder or a transfer cylinder, having a metallic cylinder basic body, which has an outer surface area and a lockup slot, wherein the cylinder basic body is coated in a region of the outer surface area and in a region of the lockup slot by autocatalytic and/or chemical deposition with a coating containing nickel, and wherein a coating containing chromium is applied to the coating containing nickel at least in the region of the outer surface area of the cylinder basic body by electrodeposition.

14. A method for coating a printing press cylinder, comprising:
a) providing a printing press cylinder with a metallic cylinder basic body, which has an outer surface area and a lockup slot;
b) applying a coating containing nickel to the cylinder basic body in a region of the outer surface area and in a region of the lockup slot by autocatalytic and/or chemical deposition; and
c) applying a coating containing chromium to the coating containing nickel at least in the region of the outer surface area of the cylinder basic body;
wherein no refinishing step is performed after the coating steps.
